(19) United States
(12) Patent Application Publication
(10) Pub. No.: US 2007/0226778 A1
(43) Pub. Date: Sep. 27, 2007

(54) Bluetooth theft protection

(76) Inventor: Jorg Pietruszka, Bochum (DE)

Correspondence Address: MORGAN & FINNEGAN, LLP, 3 World Financial Center, New York, NY, 10281-2101, US

(21) Appl. No.: 11/385,911

(22) Filed: Mar. 22, 2006

(51) Int. Cl. H04L 9/32

(52) U.S. Cl. 726/2

(57) ABSTRACT

A method and apparatus performs setting an operational state to one of a locked state to prevent establishing of a trusted relationship with a remote device or an unlocked state to allow establishing of a trusted relationship with a remote device; and controlling whether the wireless communications device is able to establish a trusted relationship with a remote device according to the set operational state.

### FIELD OF THE INVENTION

The present invention relates to wireless communications. More particularly, the present invention relates to control of access to wireless devices, such as accessory devices.

### BACKGROUND

Wireless technologies, such as of the short-range type, are becoming more prevalent or common in consumer electronic goods, products or devices and are playing a greater role in their operation and functionality particularly when communicating or operating along with other devices. For example, such technologies are now being used to provide wireless interoperability between devices, including for example a device and its accessories (e.g., a mobile phone and its headphone, etc.).

One such wireless technology is Bluetooth. Bluetooth is a system that enables wireless communications devices to communicate with each other over radio frequency (RF) communications, and to request and receive resources or services. It can be used to create ad hoc networks of up to eight devices, where one device is referred to as a master device. The other devices are referred to as slave devices. The slave device(s) can communicate with the master device and with each other via the master device. The Bluetooth Special Interest Group, Specification of the Bluetooth System for Version 2.0+EDC, Volume 0 (Master Table of Contents & Compliance Requirements), Volume 1 (Architecture & Terminology Overview), Volume 2 (Core System Package [Controller volume]) and Volume 3 (Core System Package [Host volume], issued Nov. 4, 2004, describe the principles of Bluetooth device operation and communication protocols. These documents are incorporated herein by reference in its entirety. The devices operate in about the 2.4 GHz radio band reserved for general use by Industrial, Scientific, and Medical (ISM) applications. Bluetooth devices are designed to find other Bluetooth devices within their communications range and to discover what services they offer. Other short-range networks also exist. Examples of such networks include wireless local area networks (WLANs), such as IEEE 802.11 and HIPERLAN.

However, wireless communications devices, such as those with Bluetooth capability, can be accessed by anyone who is in physical possession of the device. For instance, physical possession allows such a Bluetooth device to be brought into discoverable mode so that a Bluetooth PIN can be entered.

### SUMMARY

In accordance with an embodiment, a method, apparatus or tangible computer medium (which stores computer executable code) performs or facilitates setting an operational state to one of a locked state to prevent establishing of a trusted relationship with a remote device or an unlocked state to allow establishing of a trusted relationship with a remote device; and controlling whether the wireless communications device is able to establish a trusted relationship with a remote device according to the set operational state.

In accordance with another embodiment, a method, apparatus or tangible computer medium (which stores computer executable code) performs or facilitates conducting communications with a remote device, across a wireless medium; and causing an operational state of the remote device to be set to one of a locked state in which the remote device is prevented from establishing a trusted relationship with a wireless communications device or an unlocked state in which the remote device is allowed to establish a trusted relationship with a wireless communications device.

In accordance with a further embodiment, a method, apparatus or tangible computer medium (which stores computer executable code) performs or facilitates receiving a request to establish a trusted relationship with an unknown remote device, across a wireless medium; checking on a current operational state to ascertain whether to allow or prevent establishing of a trusted relationship with the unknown remote device, the operational state being one of a locked state that prevents establishing of a trusted relationship or an unlocked state that allows establishing of a trusted relationship; and allowing or preventing a trusted relationship to be established with the unknown remote device, according to the current operational state.

In accordance with another embodiment, a method, apparatus or tangible computer medium (which stores computer executable code) performs or facilitates enabling or disabling of one or more functions of the wireless communications device based on whether there is a remote device having a trusted relationship with the wireless communications device in a vicinity thereof. For example, the one or more functions of the wireless communications device can be disabled if there are no remote devices having a trusted relationship with the wireless communications device in a vicinity thereof. Further, a method, apparatus or tangible computer medium (which stores computer executable code) can perform or facilitate setting which functions from a plurality of functions are to be enabled or disabled in such situations.

In accordance with yet another embodiment, a method, apparatus or tangible computer medium (which stores computer executable code) performs or facilitates causing one or more functions of a remote device to be set to an enabled state or a disabled state, the enabled state or disabled state defining the operability of the one or more functions according to whether there is another device having a trusted relationship with the remote device in a vicinity thereof.

These and other exemplary embodiments and aspects are described in greater detail below.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The various embodiments will be described with reference to the accompanying drawings, wherein:

FIG. 1 is a diagram of an exemplary operational environment, according to an embodiment;

FIGS. 2A and 2B are diagrams showing exemplary operations between wireless communications devices pertaining to a locked state according to an embodiment;

FIGS. 3A and 3B are diagrams showing exemplary operations between wireless communications devices pertaining to an unlocked state according to an embodiment;

FIGS. 3C and 3D are diagrams showing exemplary operations of a wireless communications device pertaining to the operability of one or more functions of the device depending on other device(s) in a vicinity (or range) thereof in accordance with an embodiment;

FIGS. 4A and 4B are flow diagrams of exemplary processes by which the operational state of a wireless communications device is configured in accordance with an embodiment;

FIGS. 5A and 5B are flow diagrams of exemplary processes by which the operational state of a wireless communications device is changed in accordance with an embodiment;

FIG. 6A is a flow diagram of an exemplary process by which a wireless communications device is operated according to its operational state in accordance with an embodiment;

FIG. 6B is a flow diagram of an exemplary process by which a wireless communications device enables or disables operation of one or more functions of the device depending on other device(s) in a vicinity (or range) thereof in accordance with an embodiment;

FIG. 7 is a diagram of an exemplary device architecture according to an embodiment;

FIG. 8 is a diagram of an exemplary wireless communications device implementation according to an embodiment;

FIGS. 9A and 9B illustrate exemplary graphical user interfaces (GUI) through which an operational state of a wireless communications device may be configured in accordance with an embodiment; and

FIGS. 9C and 9D illustrate exemplary graphical user interfaces (GUI) through which the operability of one or more functions of a wireless communications device may be configured in accordance with an embodiment.

### DETAILED DESCRIPTION OF VARIOUS EMBODIMENTS

### I. Exemplary Operational Environment

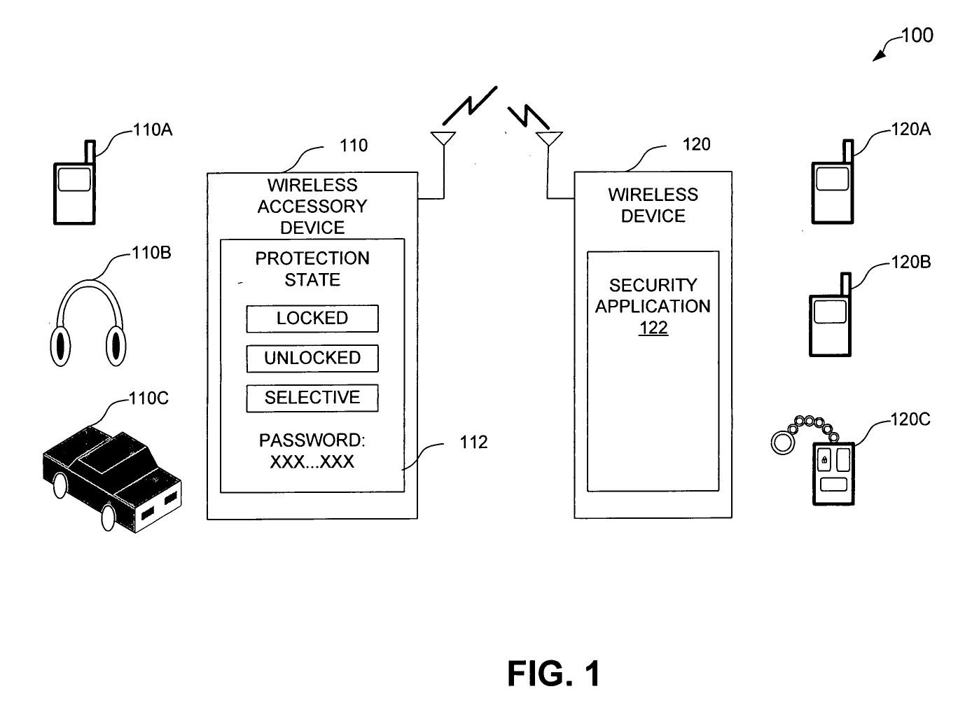

Before describing the various embodiments in detail, it is helpful to first describe an environment in which such embodiments may be employed. Accordingly, FIG. 1 is a diagram of an exemplary operational environment 100. This environment includes one or more wireless communications devices (WCDs), such as WCD 110 and WCD 120, which can establish trusted relationships with each other or with other devices to facilitate subsequent wireless communications between the trusted devices and/or set or change an operational state of device pertaining to the handling of the establishment of trusted relationships with other devices.

As shown, WCD 110 includes operational state(s) which control its ability to establish a trusted relationship with other devices, such as WCD 120 or other devices. As shown by reference to numeral 112, the operational states may include a locked state to prevent (or prohibit) establishing of a trusted relationship with a remote device or an unlocked state to allow establishing of a trusted relationship with a remote device. Other operational states may also be included such as a selective state, e.g., selective locked or selective unlocked, in which a particular subset or type of device, which may be defined by some discernable category or characteristic (e.g., manufacturer, type of device, and so forth), may be allowed or prevented from establishing a trusted relationship. The operational states may be implemented through a security application resident in one or both of WCD 110, 120.

Access to change the operational state of WCD 110 may be password-protected. For example, a password may be required to set or change the operational state. This password may be defined or changed by a user, randomly generated, predefined and so forth. This password may be further encrypted, as stored or when transmitted between devices.

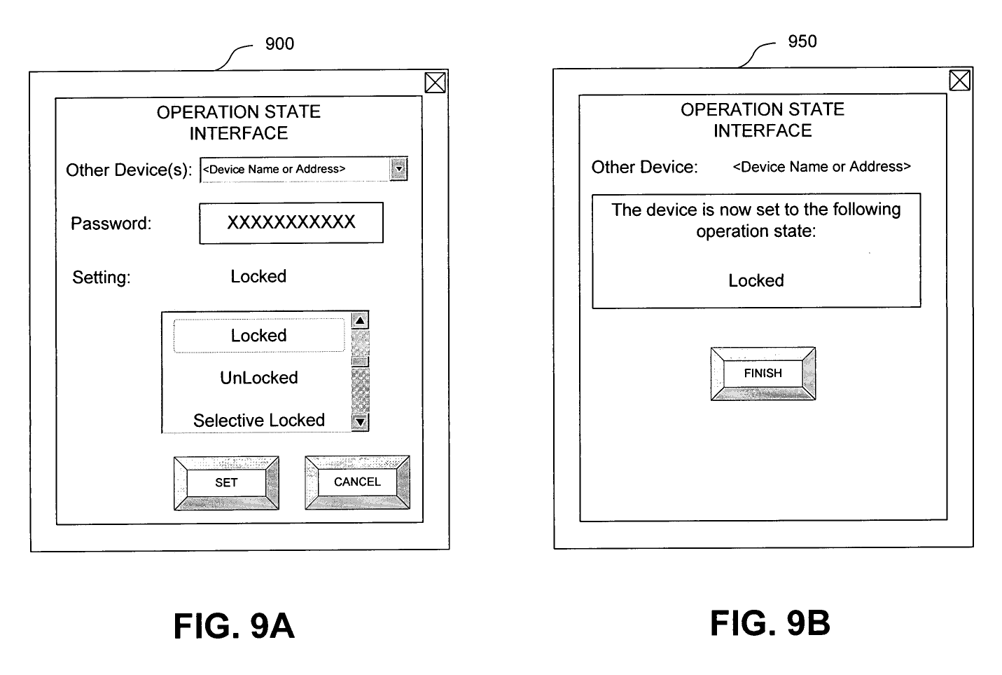

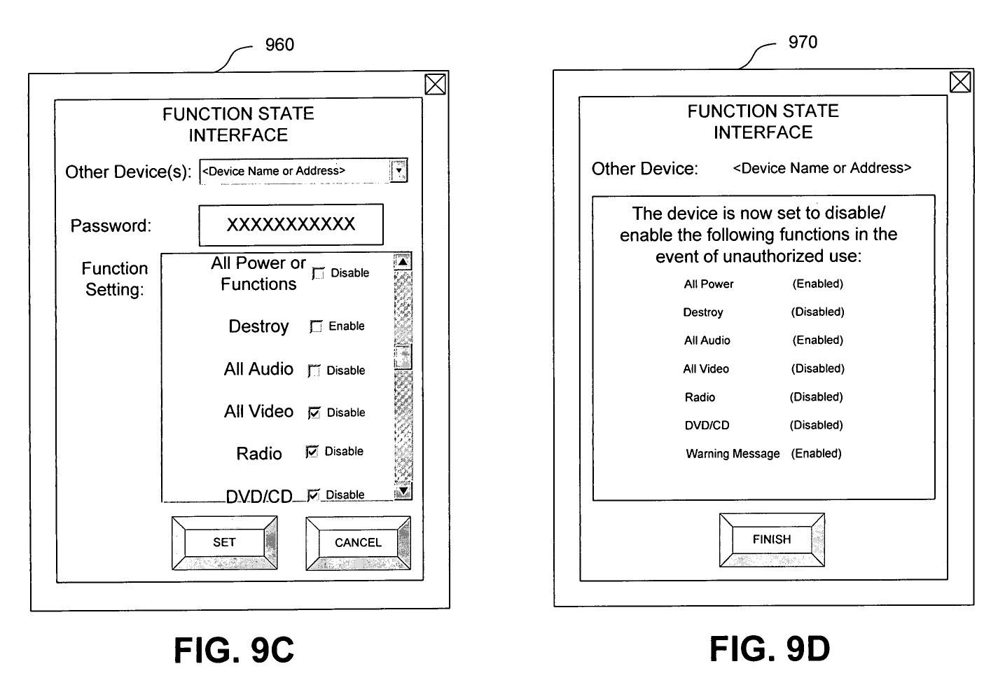

WCD 120 can include a component, such as a security application 122, through which WCD 120 may interact with WCD 110 and set or change the operational state of WCD 110. The security application 122 may provide a user interface through which a user can view remote devices within a proximity, select a device, enter a password and select the operational state to be set, and set or change the operational state of the selected device accordingly. An example of such interfaces are described below in more detail with reference to FIGS. 9A and 9B.

In this example, WCD 110 may be an accessory or a peripheral device for WCD 120, and may operate together with WCD 120 when an appropriate communications connection is established over a wireless medium, such as through short-range wireless technology (e.g., RF technology). For example, WCD 110 may be an accessory such as a mobile phone or personal digital assistant (PDA) 110A, a headset or headphone 110B or a vehicle or a component of the vehicle 110C. These exemplary accessories 110A, 110B and 110C may be an accessory of WCD 120 such as a mobile phone or PDA 120A, mobile phone or PDA 120B and key fob 120C, respectively. The following are simply examples of WCDs 110, 120 which for example may take the form of other portable or non-portable devices such as computers (e.g., PC, laptops, etc.), music player, microphone, car kit, headset of a car kit, and so forth.

Accordingly, in this context, accessory type devices may be locked to discourage unauthorized access or theft of the device among other things. For instance, at the time of delivery to the customer, an accessory may be unlocked. The user or customer can then use the accessory and establish trusted relationships with any other devices. Thereafter, the user may activate protection or security, e.g., set or change to the operation state to the locked state, such as through a security application (e.g., security application 122 of WCD 120), running on any of the devices to which there is a trusted relationship. For example, the security application may prompt the user or customer for a password. This password which can be additionally encrypted is sent to the accessory, and the operational state may be set or changed, for example, to the locked state.

To enable new trusted relationships to be established by the accessory, the user or customer may need to activate the security application on any one of the devices to which a trusted relationship has already been established, for example. A password may be entered and provided to the accessory device to change the operational state to the unlocked state. This device may be a different device from the one through which a locked state was previously set or changed.

By way of a further example, WCD 110 and WCD 120 can be Bluetooth-enabled devices, which are capable of establishing trusted relationships with each other or with other Bluetooth devices through a process or operation, generally referred to as pairing. Bluetooth pairing is described below in greater detail. When Bluetooth is used, the password and transmission thereof may be protected by Bluetooth linksecurity (e.g., encrypted).

Although the above describes examples in which the setting or changing of an operational state of a device is controlled through another device, such setting or changing may also if desired be performed through the device itself or through some other dedicated device. When the setting or changing is performed through the device itself, additional security measures such as additional passwords (e.g., from the manufacturer) may be incorporated. This may be useful where another device, such as WCD 120 with security application 122, is unavailable (e.g., lost, destroyed, etc.) and is the only device which is able to set or change the operational state.

Although the various exemplary security or protection implementations described herein may be employed in a short range wireless environment such as Bluetooth, they may likewise be employed with other wireless environments or technologies.

### II. Exemplary Bluetooth Pairing

Bluetooth provides a mechanism and/or process by which a device may pair with another Bluetooth device to form trusted relationship(s) with one or more devices. Once a trusted pair is established, setting up a communications connection or link between the pair of devices may be streamlined, e.g., may not require implementation of a standard authentication process, which can occur between unknown or untrusted devices.

Generally, one or more pairs of devices may establish a trusted relationship by sharing or exchanging a passkey (or PIN or code). For example, a user may initiate a pairing process or operation through some Bluetooth utility software or the like on a device, such as a master device. The initiating master device may search for all Bluetooth devices in a proximity or vicinity, and prompt or allow the user to select a device, such as a slave device, from the identified devices to establish a pairing. The user may be prompted to enter a passkey on the master device. The selected slave device receives a request to pair, and requests the passkey entered on the master device. The slave device may compare the received passkey to a default or predefined passkey, or prompt the user to enter a passkey on the slave device for comparison. The use of a default passkey or entry of a passkey by a user for the slave device may be dependent on the nature of the device, e.g., whether the device is an accessory or peripheral device and/or has a user interface or the like.

In any event, the passkey is compared. If confirmed, the two devices are paired. As part of the pairing operation, a common link key may for example be created based on the passkey, a random number and a device address (e.g., BD_ADDR) or a combination thereof. Thereafter, the common link key may be employed between trusted pair to streamline the process by which two device form a communications link or connection. For example, subsequent communications may be implemented without standard authentication or passkey entries by a user or user intervention in general.

A device that wishes to communicate only with a trusted device can cryptographically authenticate the identity of the other device. Trusted devices may also encrypt data exchanged over a wireless medium as an added security. The encryption can however be turned off and passkeys can be stored on the device's file system rather than the Bluetooth component or chip itself. Since the Bluetooth address can be permanent, a pairing can be preserved even if the Bluetooth name is changed. Either device in a pairing relationship may delete the pairing between the devices. Devices may require pairing or may prompt the user before it allows a remote device to utilize any or all or some of its services.

An example of pairing implementations and creation of link key is described in chapter 4.2.2 entitled “Pairing” starting from page 251 of 814 of the Bluetooth Specification Version 2.0+EDC (Volume 3), identified above. As described in general, when two devices do not have a common link key, an initialization key (Kᵢₙᵢₜ) is created based on a PIN, and a random number and a BD_ADDR. Kᵢₙᵢₜ can be created by using a second mode in which a 128-bit link key is produced using a 128-bit RAND value and an octet user PIN. When both devices have calculated Kᵢₙᵢₜ the link key is created, and a mutual authentication is performed. The pairing procedure starts with a device sending an LMP_in_rand PDU (random number). This device is referred to as the “initiating LM” or “initiator”. The other device is referred to as the “responding LM” or “responder”.

A pairing accepted operation occurs when the initiator sends an LMP_in_rand PDU (e.g., random number) and the responder replies with an LMP_accepted PDU (e.g., pairing accepted). Both devices then calculate Kᵢₙᵢₜ based on the BD_ADDR of the responder and the procedure continues with the creation of the link key. On the contrary, if the responder rejects pairing, it sends an LMP_not_accepted PDU (e.g., pairing rejected) with the error code “pairing not allowed” after receiving an LMP_in_rand PDU (e.g., random number).

### III. Exemplary Operational Implementation

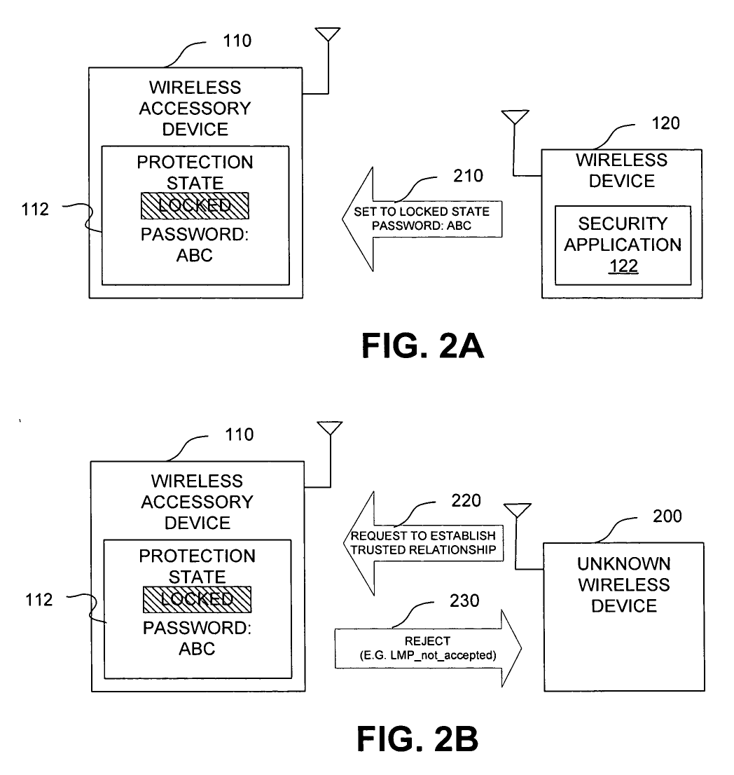

FIGS. 2A and 2B are diagrams showing exemplary operations between wireless communications devices, such as WCD 110 and WCD 120, pertaining to a locked state according to an embodiment.

For example, as shown in the exemplary scenario in FIG. 2A, WCD 120 sets the operational state of WCD 110 to the Locked state at flow 210, such as through the security application 122 resident on WCD 120. As shown by reference to numeral 112, the operational state and access thereto may be password protected to prevent unauthorized access to set or change the operational state of WCD 110. The password may be encrypted before transmission.

As shown in the exemplary scenario in FIG. 2B, WCD 110 currently has its operational state set to the Locked state which is password protected (e.g., password is ABC) as shown by reference to numeral 112. In this scenario, a wireless communications device (WCD) 200 is an unknown or untrusted device which at flow 220 requests to establish a trusted relationship with WCD 110. At flow 230, WCD 110 rejects the request to establish a trusted relationship with WCD 200 since the operational state of WCD 110 is in the Locked state. In an exemplary Bluetooth context, WCD 110 may reject the establishing of a trusted relationship with WCD 200 by terminating interaction with WCD 200, preventing the process of pairing from proceeding and/or transmitting a rejection message (e.g., LMP_not_accepted).

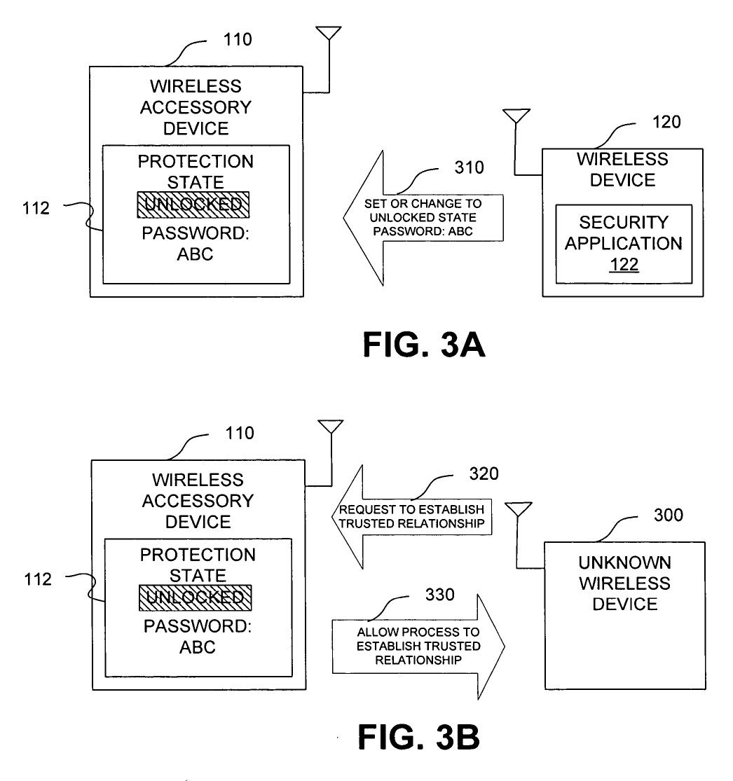

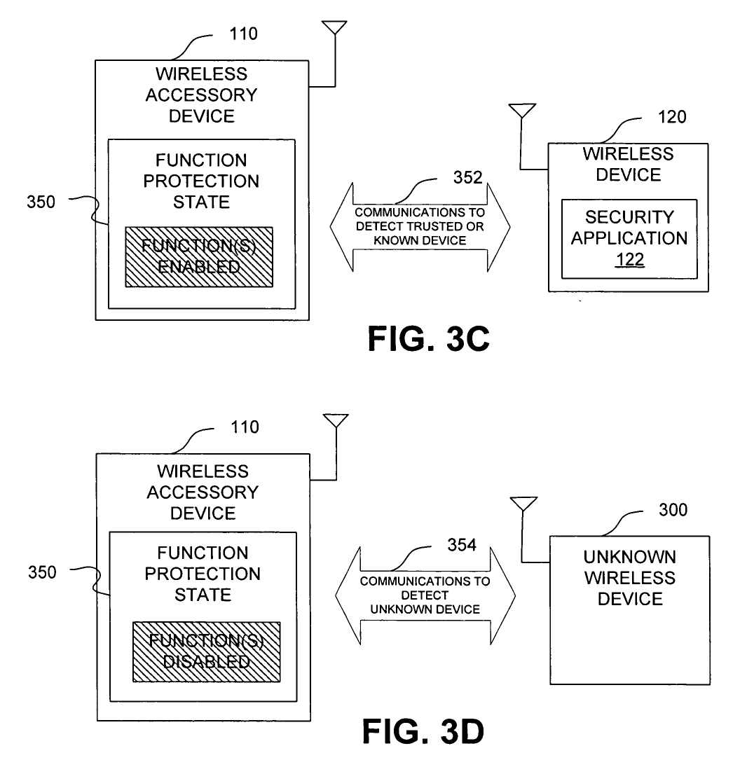

FIGS. 3A and 3B are diagrams showing exemplary operations between wireless communications devices pertaining to an unlocked state according to an embodiment.

For example, as shown in the exemplary scenario in FIG. 3A, WCD 120 sets the operational state of WCD 110 to the Unlocked state at flow 310, such as through a security application resident on WCD 120. As shown by reference to reference number 112, the operational state and access thereto may be password protected to prevent unauthorized access to set or change the operational state of WCD 110. Accordingly, WCD 120 may need to transmit an appropriate password (e.g., ABC) to set or change the operational state to the Unlocked state in this example as shown by reference number 112.

As shown in the exemplary scenario in FIG. 3B, WCD 110 currently has its operational state set to the Unlocked state which is password protected (e.g., password is ABC) by reference to numeral 112. In this exemplary scenario, a wireless communications device (WCD) 300 is an unknown or untrusted device which at flow 320 requests to establish a trusted relationship with WCD 110. At flow 330, WCD 110 allows the request to establish a trusted relationship with WCD 300 since the operational state of WCD 110 is in the Unlocked state. This may be subject to other factors such as generation of a common link key and/or authentication and so forth. In an exemplary Bluetooth context, WCD 110 may accept the establishing of a trusted relationship with WCD 300 by proceeding with the pairing process and/or transmitting an accept message (e.g., LMP_accepted).

FIGS. 3C and 3D are diagrams showing exemplary operations of a wireless communications device pertaining to the operability of one or more functions of the device depending on other device(s) in a vicinity (or range) thereof in accordance with an embodiment.

As shown in the exemplary scenario in FIG. 3C, WCD 110 detects a trusted device, such as WCD 120, in a vicinity (or range) thereof at flow 352. This detection may occur through communications initiated by WCD 110 or WCD 120. Accordingly, in this exemplary situation, WCD 110 enables one or more or all functions of WCD 110, as generally shown by reference to numeral 350 reflecting the function state of the device. Further, WCD 110 may also disable one or more or all security functions (e.g., warning message, etc.).

As shown in the exemplary scenario in FIG. 3D, WCD 110 does not detect any trusted device or a particular trusted device, in a vicinity (or range) thereof at flow 354. This detection may involve communications initiated by WCD 110 or other devices such as WCD 300 in a vicinity of WCD 110. Accordingly, in this exemplary situation, WCD 110 disables one or more or all functions of WCD 110, as generally shown by reference to numeral 350 reflecting the function state of the device. Further, WCD 110 may also enable one or more or all security functions (e.g., warning message, etc.).

By way example, WCD 110 may be a vehicle and WCD 120 may be a device (e.g., key fob, mobile phone or PDA, etc.) carried by the vehicle's owner or other authorized user. If there are no trusted devices in a vicinity of the vehicle, then one or some or all of the functions of the vehicle can be disabled or modified and/or other security functions can also be enabled. For example, when there are no trusted devices (e.g., WCD 120) in a vicinity of the vehicle, then the following may occur: the vehicle may be immobilized, the radio would not play music but an audio message may be outputted reflecting unauthorized use (e.g., the message may say “Please use authenticated device only. Self destruction will commence in 10 seconds” or “Unauthorized access—Authenticated device required” or the like), power to one or more components of the vehicle may be turned off and so forth or a combination thereof.

In another example, WCD 110 may be a laptop computer which can only be used or is operable only when it is in the vicinity of a trusted device or a device with which it has a trusted relationship, such as WCD 120.

These are simply a few examples of types of devices (e.g., accessories), in addition to those discussed above with reference to FIG. 1 (e.g., 110A-C), in which one or more or all of their functions may be enabled or disabled or modified. Any device for which security measures are sought may employ the aspects of enabling, disabling and/or modifying as described herein.

### IV. Exemplary Operation or Process

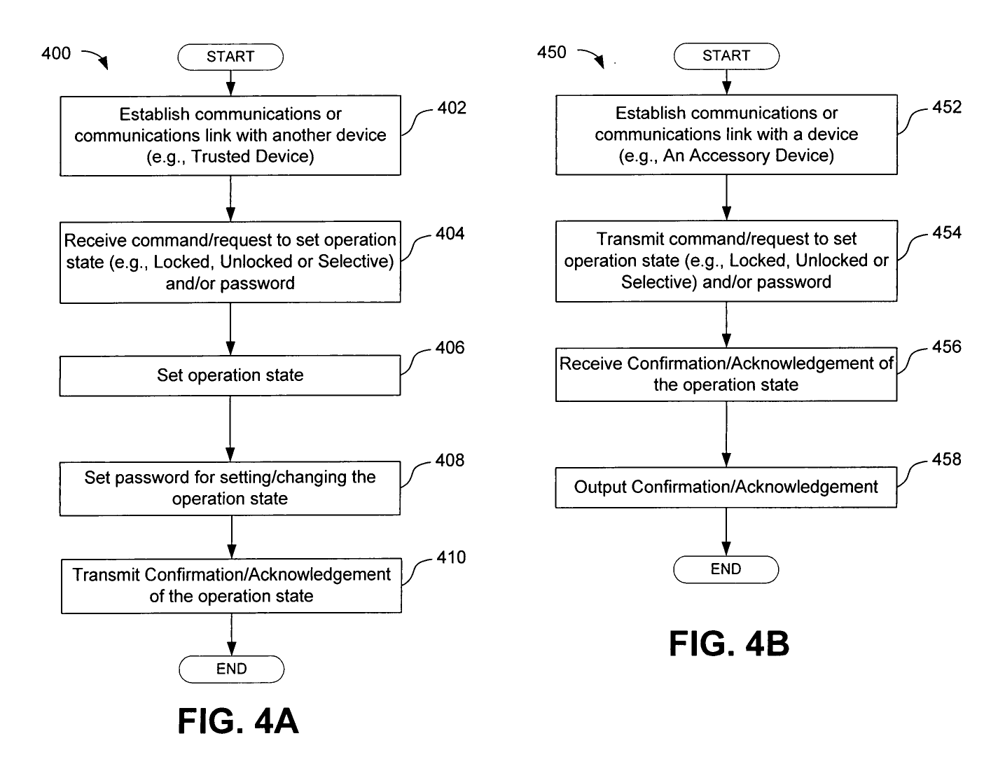

FIG. 4A is a flow diagram of an exemplary process 400 by which a wireless communications device is controlled to set its operational state, in accordance with an embodiment. By way of example, the wireless communications device may be WCD 110 as shown in FIG. 1, may be a slave device (e.g., a slave Bluetooth device) or other short-range wireless communications device, or an accessory.

The process 400 involves establishing communications such as a communications link or connection with a remote device, at step 402. By way of example, the remote device may be WCD 120 as shown in FIG. 1 and may be a master device (e.g., a master Bluetooth device) or other short-range wireless communications device. The remote device may be a trusted device, for example, a trusted pair in the context of Bluetooth.

At step 404, the wireless communications device receives signals, e.g., messages, commands or requests, to set the operational state, such as to a Locked state, an Unlocked state or a Selective state (e.g., selective locked or unlocked). In this step 404, a password may also be received.

The Selective state may reflect a selective preventing or allowing of a subset of unknown devices to enter or establish a trusted relationship based on various characteristics, including a general category (e.g., manufacturer, product, serial number), identity or address or other feature or characteristic discernable from an unknown or untrusted device. This information may be discerned in the inquiry or discovery process, or through other sensing or communications approaches. Accordingly, the subset of devices and their identifying characteristic may be set, updated, changed, stored, compared and/or used in general to selectively allow or prevent establishment of trusted relationship when the wireless device is set to the Selective state (e.g., Selective Locked or Selective Unlocked).

At step 406, the particular operational state is set, such as to a Locked state, an Unlocked state or a Selective state (e.g., Selective Locked or Unlocked) desired by the remote device. The setting operation may also be subject to receipt of an appropriate password, e.g., a default or preset password. At step 408, the password may be set or changed according to the received password(s). The received password(s) if encrypted is decrypted.

At step 410, the wireless communications device transmits a confirmation or acknowledgement of the set operational state and/or password.

FIG. 4B is a flow diagram of an exemplary process 400 by which a wireless communications device is able to control the setting of an operational state of another device, in accordance with an embodiment. By way of example, the wireless communications device may be WCD 120 as shown in FIG. 1 and may be a master device (e.g., a master Bluetooth device) or other short-range wireless communications device. The wireless communications device may be a trusted device, for example, a trusted pair in the context of Bluetooth.

The process 450 involves establishing communications such as a communications link or connection with a remote device, at step 452. By way of example, the remote device may be WCD 110 as shown in FIG. 1, may be a slave device (e.g., a slave Bluetooth device) or other short-range wireless communications device, or an accessory.

At step 454, the wireless communications device transmits signals, e.g., messages, commands or requests, to set the operational state, such as to a locked state, an unlocked state or a selective state (e.g., selective locked or unlocked) of the remote device. In this step 454, a password(s) may also be transmitted. The transmitted password(s) may be encrypted. The password(s) may include a password to access to set or change the operational state and a new password to be set or changed.

At step 456, the wireless communications device receives a confirmation or acknowledgement of the setting of the operational state and/or password from the remote device. At step 458, the wireless communications device outputs the confirmation or acknowledgement to a user.

In the examples of FIGS. 4A and 4B, the device for which the operational state is set may initially be set or reset to a default state, such as Unlocked.

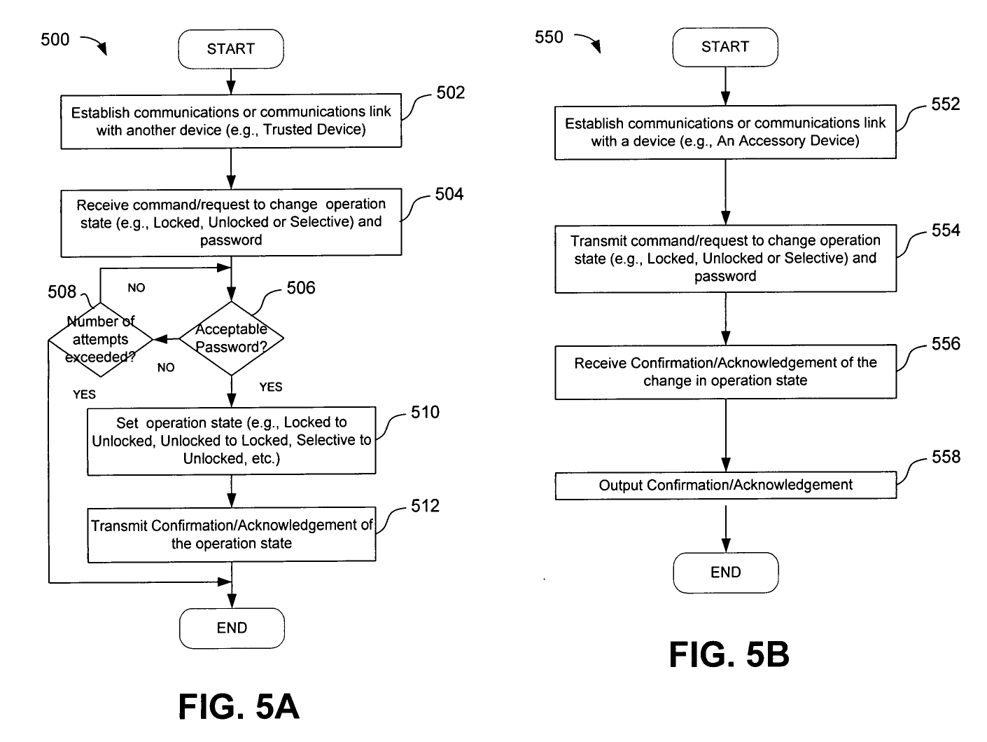

FIG. 5A is a flow diagram of an exemplary process 400 by which a wireless communications device is controlled to change its operational state, in accordance with an embodiment. By way of example, the wireless communications device may be WCD 110 as shown in FIG. 1, may be a slave device (e.g., a slave Bluetooth device) or other short-range wireless communications device, or an accessory.

The process 500 involves establishing communications such as a communications link or connection with a remote device, at step 502. By way of example, the remote device may be WCD 120 as shown in FIG. 1 and may be a master device (e.g., a master Bluetooth device) or other short-range wireless communications device. The remote device may be a trusted device, for example, a trusted pair in the context of Bluetooth.

At step 504, the wireless communications device receives signals, e.g., messages, commands or requests, to change the operational state, such as to a locked state, an unlocked state or a selective state (e.g., selective locked or unlocked). In this step 504, a password may also be received. The received password, if encrypted, may then be decrypted.

At step 506, the wireless communications device determines or checks if the received password is correct or proper. If not, the wireless communications device determines or checks if the number of attempts or unsuccessful attempts has been exceeded or reached (e.g., a threshold amount) at step 508. If the number of attempts or unsuccessful attempts has been exceeded or reached, then the particular remote device may be barred from any further attempts to access and control any features or functions of the wireless communications device, including the setting or changing of its operational state, the ability to establish a trusted relationship with the device, and so forth.

If the number of attempts or unsuccessful attempts has not been exceeded or reached, then the process 500 may inform the remote device that the password is incorrect and request re-entry of the correct password and then proceed again to step 504. Alternatively, the process 500 may be terminated and a period of time may need to have elapsed before another attempt.

Turning back to step 506, if the received password is correct or proper then the particular operational state is set or changed, such as to the particular Locked state, Unlocked state or Selective state (e.g., Selective Locked or Unlocked) desired by the remote device at step 510. At step 512, the wireless communications device transmits a confirmation or acknowledgement of the status of the operational state and/or password.

In one aspect, the above process(es) describes an exemplary approach to limit excessive attempts to re-enter password to access the setting or changing of the operational state. Other approaches may also be used. For example, the number of retries specifically for changing to an unlocked state may be limited and monitored in a similar manner as described above.

In another example, in Bluetooth version 2.0+EDC, there is provided a security aspect to address repeated attempts for authentication, which may in general be applied to provide additional security for accessing the setting or changing operations. This feature is described in chapter 5.1 entitled “Repeated Attempts” on page 799 of 814 in the Bluetooth Specification Version 2.0+EDC (Volume 3), identified above.

For example, when the password attempt fails, a waiting interval may pass before the verifier will initiate a new password/setting or changing attempt to the same claimant, or before it will respond to another password/setting or changing attempt initiated by a device claiming the same identity as the failed device. For each subsequent password/setting or changing failure with the same device address, the waiting interval may be increased exponentially. That is, after each failure, the waiting interval before a new attempt can be made, could be for example, twice as long as the waiting interval prior to the previous attempt. The waiting interval may be to a maximum. The maximum waiting interval may depend on the implementation. The waiting time may exponentially decrease to a minimum when no new failed attempts are made during a certain time period. This procedure prevents an unauthorized user from repeating the password/setting or changing procedure with a large number of different password attempts.

The devices can be configured to keep a list of individual waiting intervals for each device it has established contact with. The size of this list may be restricted to only contain the N devices with which the most recent contacts have been made. The number N may vary for different devices depending on available memory size and user environment.

FIG. 5B is a flow diagram of an exemplary process 550 by which a wireless communications device is able to control the changing of the setting of an operational state of another device, in accordance with an embodiment. By way of example, the wireless communications device may be WCD 120 as shown in FIG. 1 and may be a master device (e.g., a master Bluetooth device) or other short-range wireless communications device. The wireless communications device may be a trusted device, for example, a trusted pair in the context of Bluetooth.

The process 550 involves establishing communications such as a communications link or connection with a remote device, at step 552. By way of example, the remote device may be WCD 110 as shown in FIG. 1, may be a slave device (e.g., a slave Bluetooth device) or other short-range wireless communications device, or an accessory.

At step 554, the wireless communications device transmits signals, e.g., messages, commands or requests, to set or change the operational state, such as to a Locked state, an Unlocked state or a Selective state (e.g., Selective Locked or Unlocked) of the remote device. In this step 554, a password may also be transmitted. The transmitted password may be encrypted.

At step 556, the wireless communications device receives a confirmation or acknowledgement of the changed operational state and/or password from the remote device. At step 558, the wireless communications device outputs the confirmation or acknowledgement to a user.

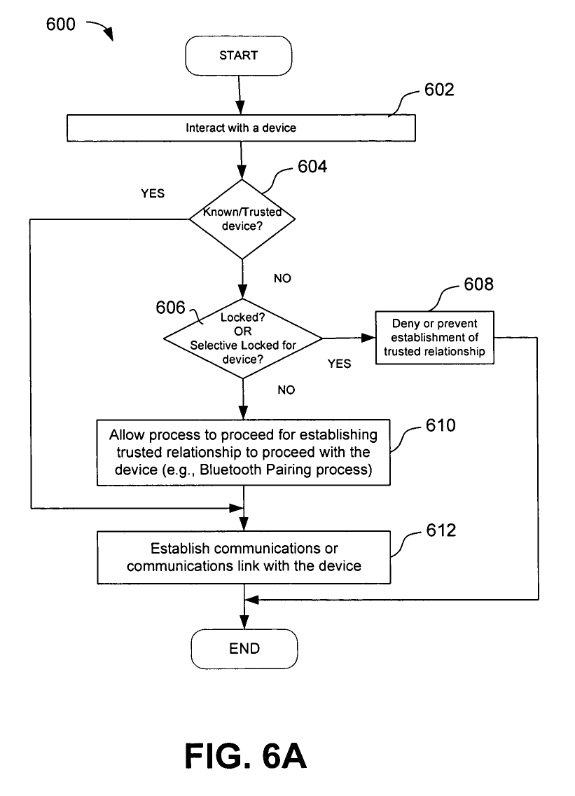

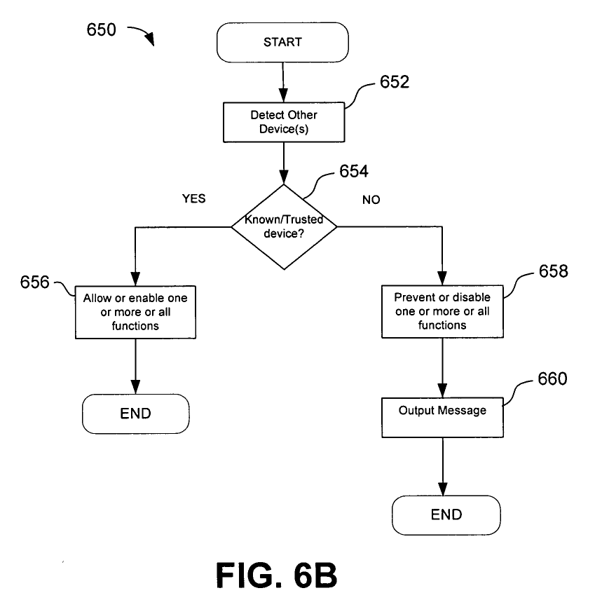

FIG. 6A is a flow diagram of an exemplary process 600 by which a wireless communications device is operated according to its operational state in accordance with an embodiment. By way of example, the wireless communications device may be WCD 110 as shown in FIG. 1, may be a slave device (e.g., a slave Bluetooth device) or other short-range wireless communications device, or an accessory.

The process 600 involves interacting with a remote device, at step 602. This interaction may involve communicating with or transmitting to or receiving information from a remote device, such as in an inquiry or discovery operation. By way of example, the remote device may be WCD 120 as shown in FIG. 1 and may be a master device (e.g., a master Bluetooth device) or other short-range wireless communications device. The remote device may be a trusted device, for example, a trusted pair in the context of Bluetooth, or an unknown device or a device that does not share a common link key or the like.

At step 604, the wireless communications device determines or checks whether the remote device is a known/trusted device or unknown/untrusted device. If the remote device is a known or trusted device, then the process 600 proceeds to step 612 in which the wireless communications device establishes communications, such as a communications link or connection, with the remote device. In this way, trusted communications may thereafter be performed between the devices to facilitate interoperability of the devices, such as in a device and accessory device relationship. In the context of Bluetooth, a trusted remote device may for example employ a common link key or the like to establish a communications line or connection without authentication or implementing other processes generally performed with non-trusted or unknown devices.

If the remote device is unknown or untrusted, then the wireless communications device determines or checks the operational state to see whether the wireless communications device is set to a Locked state or a Selective Locked state with regard to this particular remote device at step 606. If so, then the wireless communications device denies or prevents establishment of a trusted relationship with the remote device at step 608. This may involve terminating further interaction with the remote device. For example, in the Bluetooth context, the wireless communications device may prevent the pairing process from occurring and/or transmit a reject pairing response (e.g., LMP_not_accepted PDU).

Otherwise, if the operational state is set to an Unlocked state or a Selective Unlocked state with regard to this particular remote device, then the wireless communications device allows the process to proceed for establishing a trusted relationship with the remote device. This may involve generating a common link key or the like, such as with the pairing operation under Bluetooth. In this exemplary Bluetooth context, the wireless communications device may allow the pairing process to proceed and/or transmit an accept pairing response (e.g., LMP_accepted PDU). Other processes such as authentication may also be involved in the initial establishment of a trusted relationship. Once a trusted relationship is established, then the process 600 proceeds to step 612 in which the wireless communications device establishes communications, such as a communications link or connection, with the remote device. In this way, trusted communications may thereafter be performed or easily established between the devices to facilitate interoperability of the devices, such as in a device and accessory device relationship.

FIG. 6B is a flow diagram of an exemplary process 650 by which a wireless communications device enables or disables operations of one or more functions of the device depending on other device(s) in a vicinity (or range) thereof in accordance with an embodiment. By way of example, the wireless communications device may be WCD 110 as shown in FIG. 1, or other short-range wireless communications device, or an accessory.

The process 600 involves detecting other device(s) in a vicinity (or range) at step 652. This detecting operation may involve communications initiated by the wireless communications device or other device(s).

At step 654, the wireless communications device determines whether there is a known or trusted device in a vicinity of the device. If there is a known or trusted device, then the process proceeds to step 656 in which one or more or all functions of the wireless communications device are enabled or allowed to operate or disables one or more security functions. For example, the primary functions of the wireless communications device are enabled (e.g., a vehicle may be operated as well as its components including for example its audio devices, video devices and so forth).

If there is no known or trusted device, the wireless communications device disables, prevents or modifies operation of one or more or all of the functions of the communications device or enables one or more security functions, at step 658. For example, the primary functions of the wireless communications device may be rendered inoperable, an output function (e.g., audio or video) may be modified to output a warning message, or other security functions may be enabled (e.g., cutting off power to one or more components of the wireless communications device, etc.), and so forth.

At step 660, for example, the wireless communications device may output a message, such as a warning message (e.g., requesting authenticated device, indicating unauthorized access, etc.).

The processes or operations of FIGS. 4A, 4B, 5A, 5B, 6A and 6B are provided as examples, and not in limitation. Accordingly, variations to these operations, such as the addition of steps, the removal of steps, and changes in their order of performance, are within the scope of the present invention.

### V. Exemplary Wireless Communications Device

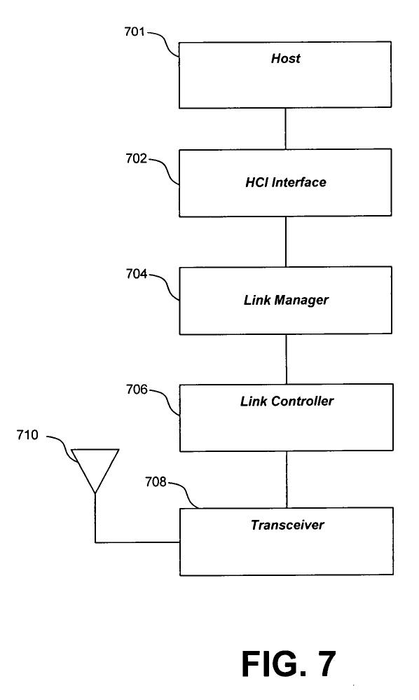

FIG. 7 is a block diagram showing an exemplary wireless communications device architecture, which may be used for devices 110 and 120, in accordance with the various embodiments described herein for communicating information (e.g., data, audio, video, etc.). Although this architecture is described in the context of Bluetooth communications, it may be employed with other wireless communications technologies.

The device architecture of FIG. 7 includes a host 701, a host controller interface (HCI) 702, a link manager 704, a link controller 706, a transceiver 708, and an antenna 710.

Host 701 is responsible for functions involving user applications and higher protocol layers. Therefore, host 701 may include various application(s) to facilitate interoperability between devices 110 and 120, such as between accessory devices (e.g., car, headset or headphone, etc.) and their primary devices (e.g., mobile device or key fob, etc.). The host 701 may also include a security application, such as security application 122 of FIG. 1.

Link manager 704 performs functions related to link set-up, security and control. These functions involve discovering corresponding link managers at remote devices and communicating with them according to the link manager protocol (LMP). More particularly, link manager 704 exchanges LMP PDUs with link managers at remote devices.

Link manager 704 exchanges information with host 701 across HCI 702. This information may include commands received from host 701, and information transmitted to host 701. Examples of such commands is host 701 (when in a master device) directing the device to establish a trusted relationship and (when in a slave device) directing the device to establish a trusted relationship with another device. HCI 702 defines a set of messages, which provide for such exchanges of information.

Link controller 706 operates as an intermediary between link manager 704 and transceiver 708. Link controller 706 also performs baseband processing for transmissions, such as error correction encoding and decoding. In addition, link controller 706 exchanges data between corresponding link controllers at remote devices according to physical layer protocols. Examples of physical layer protocols include retransmission protocols such as the automatic repeat request (ARQ) protocol.

Transceiver 708 is coupled to antenna 710. Transceiver 708 includes electronics to (in conjunction with antenna 710) exchange wireless signals with devices. Such electronics include modulators, demodulators, amplifiers, and filters.

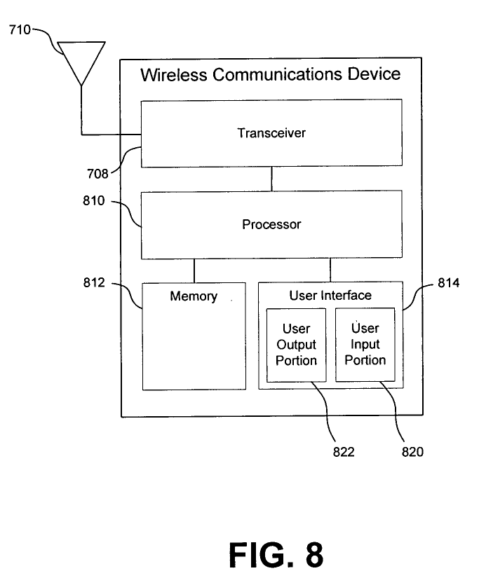

Device architectures, such as the architecture of FIG. 7, may be implemented in hardware, software, firmware, or any combination thereof. One such implementation is shown in FIG. 8. This implementation includes a processor 810, a memory 812, a user interface 814. In addition, the implementation of FIG. 8 includes transceiver 708 and antenna 710.

Processor 810 controls device operation. As shown in FIG. 8, processor 810 is coupled to transceiver 708. Processor 810 may be implemented with one or more microprocessors that are each capable of executing software instructions stored in memory 812.

Memory 812 includes random access memory (RAM), read only memory (ROM), and/or flash memory, and stores information in the form of data and software components (also referred to herein as modules). The data stored by memory 812 may be associated with particular software components.

The software components stored by memory 812 include instructions (also referred to as computer program logic) that can be executed by processor 810. Various types of software components may be stored in memory 812. For instance, memory 812 may store software components that control the operation of transceiver 708. Also, memory 812 may store software components that provide for the functionality of communications host 701, HCI 702, link manager 704, and link controller 706.

As shown in FIG. 8, user interface 814 is also coupled to processor 810. User interface 814 facilitates the exchange of information with a user. FIG. 8 shows that user interface 814 includes a user input portion 820 and a user output portion 822. User input portion 820 may include one or more components that allow a user to input information. Examples of such components include keypads, touch screens, and microphones. User output portion 822 allows a user to receive information from the device. Thus, user output portion 822 may include various components, such as a display, and one or more audio speakers. Exemplary displays include liquid crystal displays (LCDs), and video displays. The user interface 814 can allow a user to perform various tasks including among other things those tasks associated with the security or protection embodiments described herein, including for example setting or changing of the operational state (e.g., Locked, Unlocked, Selective, etc.) of the device or other remote devices, entering or changing passwords, and so forth.

The elements shown in FIG. 8 may be coupled according to various techniques. One such technique involves coupling transceiver 708, processor 810, memory 812, and user interface 814 through one or more bus interfaces. In addition, each of these components is coupled to a power source, such as a removable and/or rechargeable battery pack (not shown).

The components and their configuration of the wireless communications device of FIGS. 7 and 8 are provided as examples, and not in limitation. Accordingly, variations to these components or configurations, such as the addition of components, the removal of components, and changes in the functions of the components, are within the scope of the present invention.

### VI. Exemplary Graphical User Interface (GUI)

FIGS. 9A and 9B illustrate exemplary graphical user interfaces (GUIs) 900 and 950 through which an operational state of a wireless communications device may be configured in accordance with an embodiment. By way of example, the GUIs 900 and 950 may be provided by a wireless communications device, such as WCD 120 of FIG. 1 and/or may be provided through a program, such as the security application 122 of FIG. 1.

As shown, the GUI 900 includes graphical elements such as an Other Device(s) component, Password component, a Setting component and graphical buttons SET and CANCEL. The Other Device(s) component provides a list of remote devices (e.g., sensed or identified devices in a proximity), such as those detected in the vicinity of the wireless communications device. In this example, the Other Device(s) component may include a pull down box or combo box through which a user is able to select a remote device.

The Password component provides a text box or other graphical input by which a user can enter a password to access and set or change an operational state of a remote device or to set or change a password. The password may be any signal or code which may include a combination of characters (e.g., numbers, letters, symbols, space, etc.), a Personal Identification Number (PIN), or other signal characteristic used to protect access, such as to the setting and/or changing of the operational state of a remote device.

The Setting component displays the current selection, e.g., Locked, as well as provides a graphical element to select an operational state (e.g., Locked, Unlocked, Selective, etc.) to be set or changed. In this example, the Setting component may use a list box through which a particular operational state may be selected.

Once the password and/or setting have been selected or chosen or entered (or the default device, password and/or setting has been left or a combination thereof), the user can initiate the setting or changing process of the operational state of the selected remote device, for example, by clicking on the SET button. Thereafter, communications is conducted with the selected remote device, and appropriate messages, commands or requests are sent or exchanged including for example the password and the selected state to cause the selected remote device to set or change its operational state to the selected state, e.g., Locked in this example. Otherwise, the user can click on the CANCEL button to cancel the setting or changing operation or reset each component to a default selection state.

As shown in FIG. 9B, the GUI 950 displays an Other Device(s) component, a display area and a FINISH button. The Other Device(s) component displays the current selected remote device. The display area displays a confirmation that the selected device has set its operational state to the selected state, e.g., “The device is now set to the following operational state: Locked”. The display area in general may be used to display various status information concerning the remote device or interactions with the remote device, such as indicating an incorrect password and requesting re-entry of the password, indicating that the number of incorrect or password attempts or attempts to set the operational state to the Unlocked state have been exceeded. In such as case, the particular device may be barred from accessing and controlling any features or functions of the remote device, including the setting or changing of its operational state, the ability to establish a trusted relationship with the remote device, and so forth. Other types of graphical buttons other than FINISH may be provided depending on the status (e.g., RESET—to reselect or input any of the selections and inputs such as the remote device, password and/or setting).

FIGS. 9C and 9D illustrate exemplary graphical user interfaces (GUIs) 960 and 970 through which the operability of one or more functions of a wireless communications device may be configured in accordance with an embodiment. By way of example, the GUIs 960 and 970 may be provided by a wireless communications device, such as WCD 120 of FIG. 1 and/or may be provided through a program, such as the security application 122 of FIG. 1.

As shown, the GUI 960 includes graphical elements such as an Other Device(s) component, Password component, a Function Setting component and graphical buttons SET and CANCEL. The Other Device(s) component provides a list of remote devices (e.g., sensed or identified devices in a proximity), such as those detected in the vicinity of the wireless communications device. In this example, the Other Device(s) component may include a pull down box or combo box through which a user is able to select a remote device.

The Password component provides a text box or other graphical input by which a user can enter a password to access and set or change a functional state of a remote device or to set or change a password. The password may be any signal or code which may include a combination of characters (e.g., numbers, letters, symbols, space, etc.), a Personal Identification Number (PIN), or other signal characteristic used to protect access, such as to the setting and/or changing of the functional state of a remote device.

If the devices are already trusted devices, a password may not be needed, as device authentication and/or authorization have already taken place when establishing the trusted relationship of the devices.

The Function Setting component displays the current selection as well as provides a graphical element to set whether various functions of the remote device are to be enabled (e.g., operable) or disabled (e.g., inoperable) such as when a trusted device is not in a vicinity (or range) of the remote device. In this example, the Setting component may use a list box and check box for each function listed to set the functional state of one or more or all of the functions of the remote device. The exemplary functions may include All Power or Functions, Destroy, All Audio, All Video, Radio, DVD/CD, Warning Message (FIG. 9D) or other functions including those implemented by hardware or software (or firmware). As shown in FIG. 9C, for example, All Video is selected to be disabled, Radio is selected to be disabled and DVD/CD is selected to be disabled. The above functions are simply provided as examples. Other functions including other primary functions of a remote device and/or other security functions may be incorporated or not incorporated as well.

Once the password (if needed) and/or setting have been selected or chosen or entered (or the default device, password and/or setting has been left or a combination thereof), the user can initiate the setting or changing process of the functional state(s) of the selected remote device, for example, by clicking on the SET button. Thereafter, communications is conducted with the selected remote device, and appropriate messages, commands or requests are sent or exchanged including for example the password and the selected functional state(s) to cause the selected remote device to set or change its functional state(s) accordingly. Otherwise, the user can click on the CANCEL button to cancel the setting or changing operation or reset each component to a default selection state.

As shown in FIG. 9D, the GUI 970 displays an Other Device(s) component, a display area and a FINISH button. The Other Device(s) component displays the current selected remote device. The display area displays a confirmation that the selected device has set its functional state(s) to the selected state(s), e.g., “The device is now set to disable/enable the following functions in the event of unauthorized use: All Power or Function (Enabled), Destroy (Disabled), All Audio (Enabled), All Video (Disabled), Radio (Disabled), DVD/CD (Disabled) and Warning Message (Enabled). The display area in general may be used to display various status information concerning the remote device or interactions with the remote device, such as indicating “no authority” or an incorrect password and requesting re-entry of the password, indicating that the number of incorrect or password attempts or attempts to set the functional state(s) have been exceeded. In such as case, the particular device may be barred from accessing and controlling any features or functions of the remote device, including the setting or changing of its functional state(s), the ability to establish a trusted relationship with the remote device, and so forth. Other types of graphical buttons other than FINISH may be provided depending on the status (e.g., RESET—to reselect or input any of the selections and inputs such as the remote device, password and/or setting).

Although FIGS. 9A, 9B, 9C and 9D are described in these examples to set or change an operational or functional state(s) of a remote device, these interfaces in general may be used to set or change the operational or functional state(s) of the wireless communications device itself. Further, the GUIs 900, 950, 960, 970 and their configuration are simply examples. Such GUIs may be configured to display information in a different manner, to provide or use different graphical elements, and to include or not include or to modify the displayed information and graphical elements and the placement thereof. Other types of interfaces both graphical and non-graphical may also be used as desired. Furthermore, other components may also be incorporated to provide for other forms of password entry, such as of the biometric type (e.g., physical or behavior characteristic of the user—fingerprint), as desired.

### VII. CONCLUSION

While various embodiments of the present invention have been described above, it should be understood that they have been presented by way of example only, and not in limitation. For instance, although examples have been described involving short-range wireless communications such as Bluetooth, other wireless communications technologies and systems are within the scope of the present invention.

Further, although examples have been described with respect to slave or master devices, these examples are simply illustrative. The roles of a master device and slave device may be easily switched or interchanged (e.g., the operations performed by a master device such as described herein may instead be performed by a slave device, or vice-a-versa). For example, in the context of Bluetooth, where there are two or more devices conducting Bluetooth communications, a central device communicating with the other devices does not need to be a Bluetooth master device, but can be a slave device communicating with plural master devices in different piconets such as in a scatternet.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
setting an operational state of a wireless communications device to one of a locked state in which the wireless communications device is prevented from establishing a trusted relationship with a remote device or an unlocked state in which the wireless communications device is allowed to establish a trusted relationship with a remote device; and
controlling whether the wireless communications device is able to establish a trusted relationship with a remote device according to the set operational state.

2. The method according to claim 1, wherein the wireless communications device communicates with a remote device though short range (radio frequency) RF communications.

3. The method according to claim 2, wherein the wireless communications device communicates with a remote device through Bluetooth.

4. The method according to claim 1, wherein the trusted relationship to be established comprises a Bluetooth pairing with a remote device.

5. The method according to claim 4, wherein the controlling operation prevents the wireless communications device from pairing with a remote device that does not share a common link key, when the wireless communications device is set to the locked state.

6. The method according to claim 4, wherein the controlling operation allows the wireless communications device to pair with a remote device that does not share a common link key, when the wireless communications device is set to the unlocked state.

7. The method according to claim 4, wherein the controlling operation allows the wireless communications device to establish communications connection with a remote device that is already paired to the wireless communications device, even through the wireless communications device is set to the locked state.

8. The method according to claim 1, wherein the controlling operation allows the wireless communications device to establish a communications connection with a remote device that has already established a trusted relationship with the wireless communications device, even though the wireless communications device is set to the locked state.

9. The method according to claim 1, further comprising changing the operational state of the wireless communications device from one of the locked or unlocked state to the other of the locked or unlocked state.

10. The method according to claim 9, wherein access to change or to set the operational state of the wireless communications device is password protected.

11. The method according to claim 10, wherein a number of password entry attempts or setting or changing attempts is limited to a predetermined number.

12. The method according to claim 10, wherein the operational state of the wireless communications device is set or changed through a remote device.

13. The method according to claim 12, wherein the wireless communications device is a slave device and the remote device through which the operational state is changed is a master device.

14. The method according to claim 13, wherein the operational state is set or changed through a security application resident on the master device.

15. The method according to claim 13, wherein the master device and slave device are paired Bluetooth devices.

16. The method according to claim 1, wherein the wireless communications device is an accessory.

17. The method according to claim 1, wherein the wireless communications device is part of or used in connection with a car.

18. The method according to claim 1, further comprising:
enabling or disabling one or more functions of the wireless communications device based on whether there is a remote device having a trusted relationship with the wireless communications device in a vicinity thereof.

19. The method according to claim 18, wherein one or more functions of the wireless communications device are disabled if there are no remote devices having a trusted relationship with the wireless communications device in a vicinity thereof.

20. The method according to claim 18, further comprising:
setting which functions from a plurality of functions are to be enabled or disabled.

21. A method comprising:
conducting communications with a remote device, across a wireless medium; and
causing an operational state of the remote device to be set to one of a locked state in which the remote device is prevented from establishing a trusted relationship with a wireless communications device or an unlocked state in which the remote device is allowed to establish a trusted relationship with a wireless communications device.

22. The method according to claim 21, wherein the causing to be set operation comprises transmitting one or more commands to the remote device to set the operational state of the remote device.

23. The method according to claim 21, further comprising transmitting a password to the remote device to enable setting of the operational state.

24. The method according to claim 23, wherein the password is provided by a user through a user interface.

25. The method according to claim 21, further comprising causing the operational state of the remote device to be changed from one of the locked or unlocked state to the other of the locked or unlocked state.

26. The method according to claim 25, wherein the causing to be changed operation comprises transmitting one or more commands to the remote device to change the operational state of remote device.

27. The method according to claim 25, further comprising transmitting a password to the remote device to enable changing of the operational state.

28. The method according to claim 25, wherein the causing to be set operation and the causing to be changed operation are performed through a security application.

29. The method according to claim 21, wherein the communicating and the causing operations are performed by a master Bluetooth device and the remote device is a slave Bluetooth device.

30. The method according to claim 29, wherein the master and slave Bluetooth devices are paired.

31. The method according to claim 21, wherein the trusted relationship to be established comprises a Bluetooth pairing with a wireless communications device.

32. The method according to claim 21, further comprising:
causing one or more functions of the remote device to be set to an enabled state or a disabled state, the enabled state or disabled state defining the operability of the one or more functions according to whether there is another device having a trusted relationship with the remote device in a vicinity thereof.

33. The method according to claim 32, wherein the one or more functions of the remote device are disabled if there are no other devices having a trusted relationship with the wireless communications device in a vicinity thereof.

34. A method comprising:
receiving a request to establish a trusted relationship with an unknown remote device, across a wireless medium;
checking on a current operational state to ascertain whether to allow or prevent establishing of a trusted relationship with the unknown remote device, the operational state being one of a locked state that prevents establishing of a trusted relationship or an unlocked state that allows establishing of a trusted relationship; and
allowing or preventing a trusted relationship to be established with the unknown remote device, according to the current operational state.

35. The method according to claim 34, wherein the trusted relationship to be established comprises a Bluetooth pairing.

36. The method according to claim 34, further comprising notifying the unknown remote device that the request has been denied when the current operational state is the locked state.

37. An apparatus, comprising:
a transceiver configured to communicate with one or more remote devices across a wireless medium;
a memory;
a processor that executes instructions stored in the memory for:
setting an operational state to one of a locked state to prevent establishing of a trusted relationship with a remote device or an unlocked state to allow establishing of a trusted relationship with a remote device; and
controlling whether to establish a trusted relationship with a remote device according to the set operational state.

38. The apparatus according to claim 37, wherein the transceiver is configured to communicate with a remote device though short range (radio frequency) RF communications.

39. The apparatus according to claim 37, wherein the trusted relationship to be established comprises a Bluetooth pairing with a remote device.

40. The apparatus according to claim 39, wherein the controlling operation prevents pairing with a remote device that does not share a common link key, when the operational state is set to the locked state.

41. The apparatus according to claim 39, wherein the controlling operation allows pairing with a remote device that does not share a common link key, when the operational state is set to the unlocked state.

42. The apparatus according to claim 39, wherein the controlling operation allows communications connection to be established with a remote device which has already been paired with the apparatus, even though the operational state is set to the locked state.

43. The apparatus according to claim 37, wherein the controlling operation allows a communications connection to be established with a remote device to which a trusted relationship has already been established, even though the operational state is set to the locked state.

44. The apparatus according to claim 37, wherein the processor further executes instructions stored in the memory for:
changing the operational state of the wireless communications device from one of the locked or unlocked state to the other of the locked or unlocked state.

45. The apparatus according to claim 44, wherein access to change or to set the operational state of the wireless communications device is password protected.

46. The apparatus according to claim 45, wherein a number of password entry attempts or setting or changing attempts is limited to a predetermined number.

47. The apparatus according to claim 45, wherein the operational state of the wireless communications device is set or changed through a remote device.

48. The apparatus according to claim 47, wherein the apparatus is a slave device and the remote device through which the operational state is changed is a master device.

49. The apparatus according to claim 48, wherein the operational state is set or changed through a security application resident on the master device.

50. The apparatus according to claim 48, wherein the master device and slave device are paired Bluetooth devices.

51. The apparatus according to claim 37, wherein the processor further executes instructions stored in the memory for:
enabling or disabling one or more functions based on whether there is a remote device having a trusted relationship with the wireless communications device in a vicinity thereof.

52. The apparatus according to claim 51, wherein the one or more functions are disabled if there are no remote devices having a trusted relationship in a vicinity.

53. The apparatus according to claim 51, wherein the processor further executes instructions stored in the memory for:
setting which functions from a plurality of functions are to be enabled or disabled.

54. A apparatus comprising:
a transceiver configured to communicate with one or more remote devices across a wireless medium;
a memory;
a processor that executes instructions stored in the memory for:
conducting communications with a remote device, across a wireless medium; and
causing an operational state of the remote device to be set to one of a locked state in which the remote device is prevented from establishing a trusted relationship with a wireless communications device or an unlocked state in which the remote device is allowed to establish a trusted relationship with a wireless communications device.

55. The apparatus according to claim 54, wherein the causing to be set operation comprises transmitting one or more commands to the remote device to set the operational state of the remote device.

56. The apparatus according to claim 55, further comprising transmitting a password to the remote device to enable setting of the operational state.

57. The apparatus according to claim 56, wherein the processor further executes instructions stored in the memory for:
providing a user interface through which a user provides the password.

58. The apparatus according to claim 54, wherein the processor further executes instructions stored in the memory for:
causing the operational state of the remote device to be changed from one of the locked or unlocked state to the other of the locked or unlocked state.

59. The apparatus according to claim 58, wherein the causing to be changed operation comprises transmitting one or more commands to the remote device to change the operational state of remote device.

60. The apparatus according to claim 59, wherein the processor further executes instructions stored in the memory for:
transmitting a password to the remote device to enable changing of the operational state.

61. The apparatus according to claim 54, wherein the apparatus is a master Bluetooth device and the remote device is a slave Bluetooth device.

62. The apparatus according to claim 61, wherein the master and slave Bluetooth devices are paired.

63. The apparatus according to claim 54, wherein the trusted relationship to be established comprises a Bluetooth pairing with a wireless communications device.

64. The apparatus according to claim 54, wherein the processor further executes instructions stored in the memory for:
causing one or more functions of the remote device to be set to an enabled state or a disabled state, the enabled state or disabled state defining the operability of the one or more functions according to whether there is another device having a trusted relationship with the remote device in a vicinity thereof.

65. The apparatus according to claim 64, wherein the one or more functions of the remote device are disabled if there are no other devices having a trusted relationship with the wireless communications device in a vicinity thereof.

66. A apparatus comprising:
a transceiver configured to communicate with one or more remote devices across a wireless medium;
a memory;
a processor that executes instructions stored in the memory for:
checking on a current operational state to ascertain whether to allow or prevent establishing of a trusted relationship with an unknown remote device from which a request is received to establish a trusted relationship with the unknown remote device, the operational state being one of a locked state that prevents establishing of a trusted relationship or an unlocked state that allows establishing of a trusted relationship; and
allowing or preventing a trusted relationship to be established with the unknown remote device, according to the current operational state.

67. The apparatus according to claim 66, wherein the trusted relationship to be established comprises a Bluetooth pairing.

68. The apparatus according to claim 66 wherein the processor further executes instructions stored in the memory for:
notifying the unknown remote device that the request has been denied when the current operational state is the locked state.

69. A tangible computer medium having computer executable code which when executed by a processor in a wireless communications device performs the following method:
setting an operational state to one of a locked state to prevent establishing of a trusted relationship with a remote device or an unlocked state to allow establishing of a trusted relationship with a remote device; and
controlling whether the wireless communications device is able to establish a trusted relationship with a remote device according to the set operational state.

70. A tangible computer medium having computer executable code which when executed by a processor in a wireless communications device performs the following method:
conducting communications with a remote device, across a wireless medium; and
causing an operational state of the remote device to be set to one of a locked state in which the remote device is prevented from establishing a trusted relationship with a wireless communications device or an unlocked state in which the remote device is allowed to establish a trusted relationship with a wireless communications device.

71. A tangible computer medium having computer executable code which when executed by a processor in a wireless communications device performs the following method:
checking on a current operational state to ascertain whether to allow or prevent establishing of a trusted relationship with an unknown remote device from which a request is received to establish a trusted relationship with the unknown remote device, the operational state being one of a locked state that prevents establishing of a trusted relationship or an unlocked state that allows establishing of a trusted relationship; and
allowing or preventing a trusted relationship to be established with the unknown remote device, according to the current operational state.
